(19) United States
(12) Patent Application Publication
(10) Pub. No.: US 2026/0261642 A1
(43) Pub. Date: Sep. 3, 2026

(54) INFORMATION PROCESSING APPARATUS AND INFORMATION PROCESSING METHOD

(71) Applicant: Sony Group Corporation, Tokyo (JP)

(72) Inventors: Masamoto HORIKAWA, Tokyo (JP); Masato AKAO, Kanagawa (JP); Yoshihiro MYOKAN, Kanagawa (JP); Kazuhiko NISHIBORI, Kanagawa (JP)

(73) Assignee: Sony Group Corporation, Tokyo (JP)

(21) Appl. No.: 19/159,894

(22) PCT Filed: Mar. 6, 2024
(86) PCT No.: PCT/JP2024/008470

§ 371 Date: Aug. 26, 2025

(30) Foreign Application Priority Data
Mar. 24, 2023 (JP) 2023-048142

(51) Int. Cl. H04N 13/302; G06F 3/0346; G06V 40/16; H04N 13/282; H04N 13/366

(52) U.S. Cl. CPC H04N 13/302; G06F 3/0346; G06V 40/172; H04N 13/282; H04N 13/366

(57) ABSTRACT

An information processing apparatus includes a control unit. The control unit acquires a camera image from a camera a relative position of which with respect to a display is fixed. The control unit acquires IMU data that is measurement data of an IMU worn by a user viewing the display. The control unit executes face recognition processing of estimating a position and posture of a face of the user on the basis of the camera image. The control unit determines whether the execution of the face recognition processing is successful. In a case where it is determined that the execution of the face recognition processing has failed, the control unit continues the estimation of the position and posture of the face of the user on the basis of the IMU data.

### FIELD

The present disclosure relates to an information processing apparatus and an information processing method.

### BACKGROUND

Conventionally, a technology of stereoscopically displaying a virtual object to be displayed as if the virtual object is present in real space has been known. For example, a stereoscopic display in which real space is defined as a light field including an infinite number of light rays, and the light rays reaching right and left eyes of a user from a virtual object are reproduced in real time according to viewpoint positions of the user has been proposed (see, for example, Patent Literature 1).

In this stereoscopic display, positions of the right and left eyes of the user are estimated by tracking using a camera and a stereoscopic image that is a parallax image group directed to the right and left eyes at the estimated positions is calculated and drawn in real time, whereby stereoscopic display is possible.

### CITATION LIST

### Patent Literature

Patent Literature 1: WO 2021/124709 A

### SUMMARY

### Technical Problem

However, the related art described above has room for further improvement in improving tracking performance of when a face of a user is tracked.

For example, when a stereoscopic image is calculated and drawn, when estimation of viewpoint positions is delayed with respect to actual movement of positions of right and left eyes, there is a risk that bodily sensation of a user is degraded. Furthermore, in a case where tracking using only a camera is performed, in a case where a face of the user is out of an angle of view of the camera, the viewpoint positions cannot be known, and it becomes difficult to continue the stereoscopic display.

Thus, the present disclosure proposes an information processing apparatus and an information processing method capable of improving tracking performance of when the face of the user is tracked.

### Solution to Problem

In order to solve the above problems, one aspect of an information processing apparatus according to the present disclosure includes a control unit. The control unit acquires a camera image from a camera a relative position of which with respect to a display is fixed. The control unit acquires IMU data that is measurement data of an IMU worn by a user viewing the display. The control unit executes face recognition processing of estimating a position and posture of a face of the user on a basis of the camera image. The control unit determines whether the execution of the face recognition processing is successful. The control unit continues the estimation of the position and posture of the face of the user on a basis of the IMU data in a case where it is determined that the execution of the face recognition processing has failed.

### BRIEF DESCRIPTION OF DRAWINGS

FIG. 1 is a schematic explanatory diagram (part 1) of an image processing method according to an embodiment of the present disclosure.

FIG. 2 is a schematic explanatory diagram (part 2) of the image processing method according to the embodiment of the present disclosure.

FIG. 3 is a block diagram illustrating a configuration example of an image processing apparatus according to the embodiment of the present disclosure.

FIG. 4 is an explanatory diagram (part 1) of an image processing method executed by the image processing apparatus.

FIG. 5 is an explanatory diagram (part 2) of the image processing method executed by the image processing apparatus.

FIG. 6 is an explanatory diagram (part 3) of the image processing method executed by the image processing apparatus.

FIG. 7 is a flowchart (part 1) illustrating a processing procedure executed by the image processing apparatus.

FIG. 8 is a flowchart (part 2) illustrating the processing procedure executed by the image processing apparatus.

FIG. 9 is a block diagram illustrating a configuration example of an image processing apparatus according to a modification example.

FIG. 10 is a hardware configuration diagram illustrating an example of a computer that realizes functions of the image processing apparatus.

### DESCRIPTION OF EMBODIMENTS

In the following, an embodiment of the present disclosure will be described in detail on the basis of the drawings. Note that in the following embodiment, overlapped description is omitted by assignment of the same reference sign to the same parts.

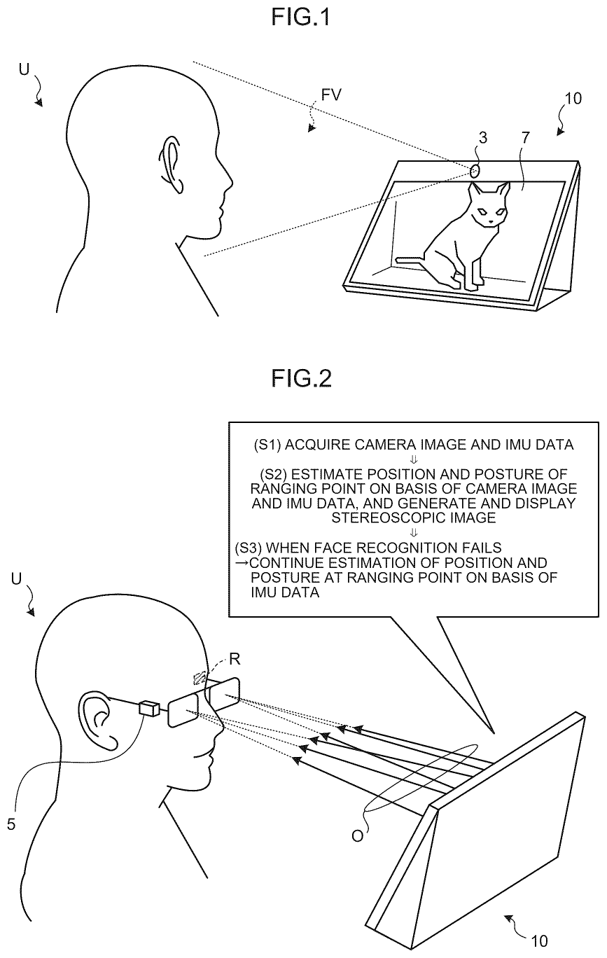

Furthermore, in the following, it is assumed that an information processing apparatus according to an embodiment of the present disclosure (hereinafter, appropriately referred to as the “present embodiment”) is an image processing apparatus 10 illustrated in FIG. 1 and subsequent drawings. Furthermore, in the following, it is assumed that an information processing method according to the present embodiment is an image processing method executed by the image processing apparatus 10.

Furthermore, the present disclosure will be described in the following order of items.
1. Outline
2. Configuration example of an image processing apparatus
3. Processing procedure
4. Modification example
4-1. Case where notification to a user is performed
4-2. Hysteresis control
4-3. Other
5. Hardware configuration
6. Conclusion

### <<1. Outline>>

FIG. 1 is a schematic explanatory diagram (part 1) of an image processing method according to an embodiment of the present disclosure. FIG. 2 is a schematic explanatory diagram (part 2) of the image processing method according to the embodiment of the present disclosure.

As illustrated in FIG. 1, the image processing apparatus 10 according to the present embodiment includes a camera 3 and a stereoscopic display 7. The camera 3 is provided in such a manner as to be able to image a face of a user U at a predetermined angle of view FV, and a position of the camera 3 is fixed in a manner relative to a position of the stereoscopic display 7. The stereoscopic display 7 stereoscopically displays a virtual object to be displayed in such a manner that the user U can visually recognize as if the virtual object is present in real space. Note that a configuration of the present embodiment is not limited to a configuration in which the camera 3 is directly fixed to a housing of the image processing apparatus 10. For example, the camera 3 may be fixed at a position away from the image processing apparatus 10 as a separate body, and the camera 3 may communicate with the image processing apparatus 10 in a wired or wireless manner.

In the stereoscopic display 7, a light distribution member such as a lenticular lens or a parallax barrier is mounted on a display panel in which pixels are arrayed, and directivity can be given to light rays emitted from the pixels by an opening in the light distribution member.

By using the directivity, the image processing apparatus 10 can separate different images for right and left eyes of the user U and display the images on the stereoscopic display 7. Thus, when the image processing apparatus 10 displays a parallax image group corresponding to a right and left parallax of the user U on the stereoscopic display 7, the user U can stereoscopically view the virtual object.

As illustrated in FIG. 2, the image processing apparatus 10 reproduces a light ray O reaching each of the right and left eyes of the user U from the virtual object in real time according to viewpoint positions of the user U.

Specifically, the image processing apparatus 10 estimates the right and left viewpoint positions of the user U by tracking using the camera 3, and calculates and draws a stereoscopic image toward each of the estimated viewpoint positions in real time.

Note that the image processing apparatus 10 sets a specific part of the face of the user U as a ranging point R, estimates a three-dimensional position and posture of the ranging point R by tracking using the camera 3, and estimates the right and left viewpoint positions of the user U on the basis of the estimation result. The ranging point R is set, for example, between eyebrows of the user U. The ranging point R may be a marker fixed to the face of the user U.

Incidentally, in this tracking, when the estimation of the ranging point R is delayed with respect to actual movement of the face of the user U, there is a risk that bodily sensation of the user U is degraded. Furthermore, in a case where tracking using only the camera 3 is performed, in a case where the face of the user U is out of the angle of view FV of the camera 3, the viewpoint positions cannot be known, and it becomes difficult to continue the stereoscopic display.

Thus, in the image processing method according to the present embodiment, the image processing apparatus 10 acquires a camera image from the camera 3 a relative position of which with respect to the stereoscopic display 7 is fixed, acquires IMU data that is measurement data of an inertial measurement unit (IMU) worn by the user U viewing the stereoscopic display 7, executes face recognition processing of estimating a position and a posture of the face of the user U on the basis of the camera image, determines whether the execution of the face recognition processing is successful, and continues estimation of the position and posture of the face of the user U on the basis of the IMU data in a case where it is determined that the execution of the face recognition processing has failed. A case where the execution of the face recognition processing has failed corresponds to, for example, a case where the face of the user U is out of the angle of view FV and tracking is lost.

Specifically, as illustrated in FIG. 2, the image processing apparatus 10 causes an IMU 5 to cooperate with the tracking using the camera 3. The IMU 5 is a device that measures three-dimensional inertial motion, and can acquire acceleration and angular velocity of the IMU 5 itself more frequently than the tracking by the camera 3. That is, the IMU 5 can perform sensing with less delay than the tracking by the camera 3. Hereinafter, the measurement data including the acceleration and the angular velocity measured by the IMU 5 will be appropriately referred to as “IMU data”.

In the image processing method according to the present embodiment, the IMU 5 is attached to an arbitrary position of a head of the user U and cooperates with the tracking by the camera 3. An attachment position and an attachment form of the IMU 5 with respect to the head of the user U are not specifically limited.

For example, the IMU 5 may be attached in a shape like a clip to glasses or the like. In addition, the IMU 5 may be attached to hair of the user U in a shape like a hair clip. In addition, the IMU 5 may be provided in glasses in advance, and attached when the user U wears the glasses. Furthermore, the IMU 5 may be built in a wearable device such as smart glasses, earphones, or a headset, and may be attached to the user U by wearing of the wearable device. Note that an example in which the IMU 5 is attached to the glasses is illustrated in FIG. 2.

Then, by adding an estimation result of a position and posture of the IMU 5, which estimation result is based on the IMU data from the IMU 5, to the estimation result of the position and posture of the ranging point R which estimation result is based on the camera image, the image processing apparatus 10 estimates the final position and posture of the ranging point R necessary for stereoscopic display.

Note that as described above, since the user U can attach the IMU 5 to any attachment position in any attachment form, a relative arrangement relationship between the ranging point R to be estimated and the IMU 5 varies depending on use cases.

On the other hand, the estimation of the final position and posture of the ranging point R requires a relative position and posture indicating a relative relationship between the position and posture of the ranging point R which position and posture are based on the camera image and the position and posture of the IMU 5 which position and posture are based on the IMU data.

Thus, in the image processing method according to the present embodiment, by dynamically estimating the relative position and posture, it is possible to reduce delay in the estimation of the final position and posture of the ranging point R and improve robustness against going out of the angle of view FV.

Specifically, as illustrated in FIG. 2, in the image processing method according to the present embodiment, the image processing apparatus 10 acquires a camera image and IMU data (Step S1). Then, the image processing apparatus 10 estimates the position and posture of the ranging point R on the basis of the camera image and the IMU data, and generates and displays a stereoscopic image (Step S2).

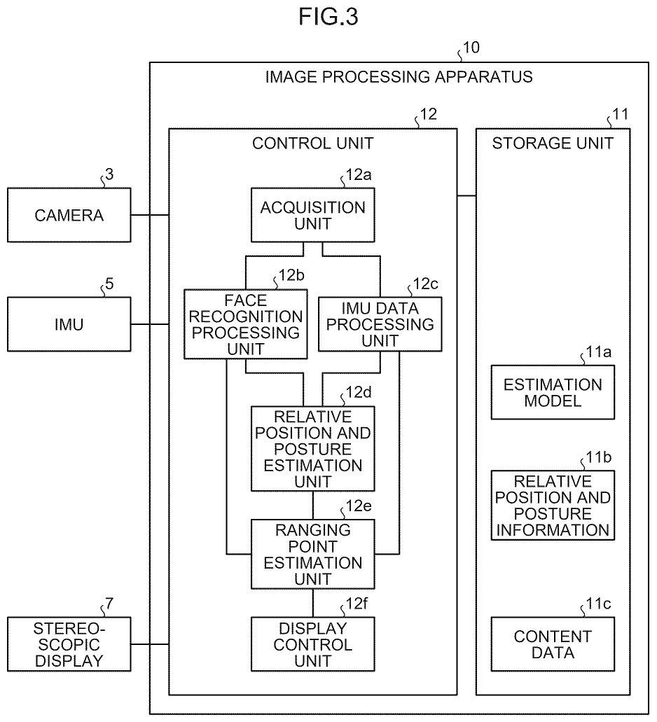

Note that in Step S2, the image processing apparatus 10 dynamically estimates the relative position and posture described above, and converts, by using an estimation result, the estimation result of the position and posture of the IMU 5 which estimation result is based on the IMU data into the position and posture of the ranging point R. Then, the image processing apparatus 10 integrates the estimation result based on the camera image and the estimation result based on the IMU data, and estimates the final position and posture of the ranging point R. Details of this point will be described later with reference to FIG. 3 to FIG. 8.

In addition, as illustrated in FIG. 2, when the face recognition fails, the image processing apparatus 10 continues the estimation of the position and posture of the ranging point R on the basis of the IMU data (Step S3). As a result, the image processing apparatus 10 can continue the operation on the basis only of the IMU data even in a case where the face of the user U is out of the angle of view FV, for example.

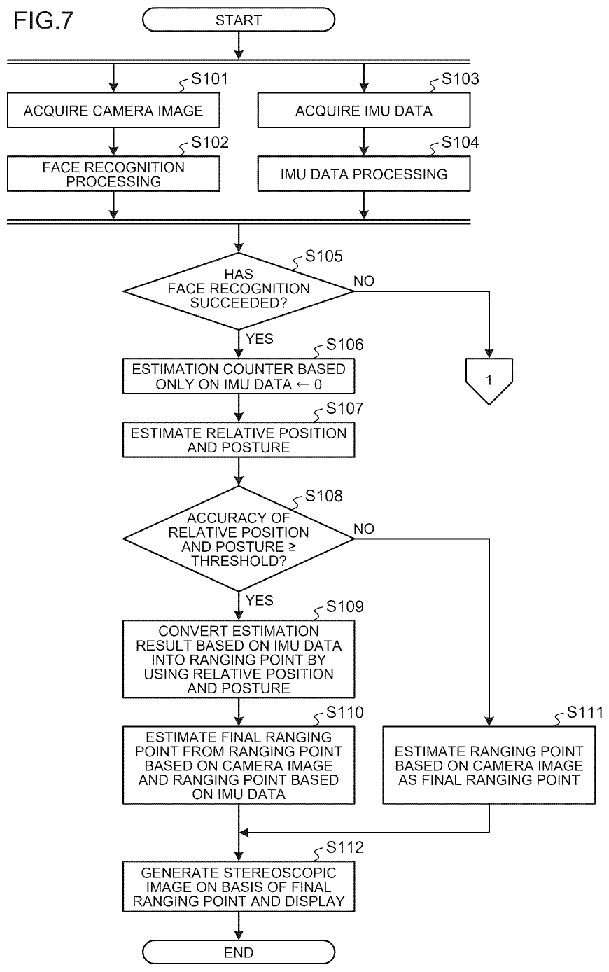

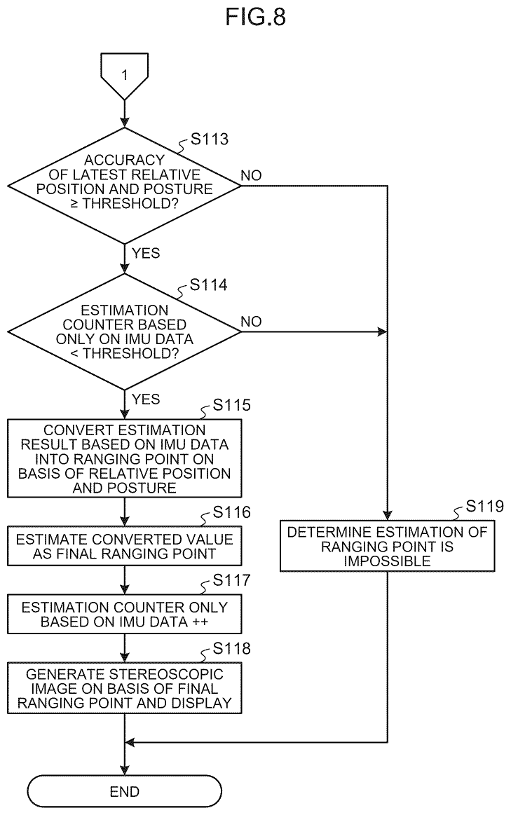

Note that due to a mechanism, the IMU 5 is accompanied by a phenomenon called drift of an absolute position due to time. However, when the determination is treated to be impossible in a case where the estimation based only on IMU data continues for a long time, an influence of the drift can be controlled. This point will be described later with reference to FIG. 7 and FIG. 8.

In such a manner, in the image processing method according to the present embodiment, the image processing apparatus 10 acquires the camera image from the camera 3 a relative position of which with respect to the stereoscopic display 7 is fixed, acquires the IMU data that is the measurement data of the IMU 5 worn by the user U viewing the stereoscopic display 7, executes the face recognition processing of estimating the position and posture of the face of the user U on the basis of the camera image, determines whether the execution of the face recognition processing is successful, and continues the estimation of the position and posture of the face of the user U on the basis of the IMU data in a case where it is determined that the execution of the face recognition processing has failed.

Thus, according to the image processing method according to the present embodiment, when the face of the user U is tracked and the position and posture of the ranging point R are estimated, it is possible to reduce the delay and improve the robustness of a case where the face of the user U is out of the angle of view FV. That is, according to the image processing method according to the present embodiment, it is possible to improve tracking performance of when the face of the user U is tracked.

Hereinafter, a configuration example of the image processing apparatus 10 according to the present embodiment will be described more specifically.

### <<2. Configuration Example of an Image Processing Apparatus>>

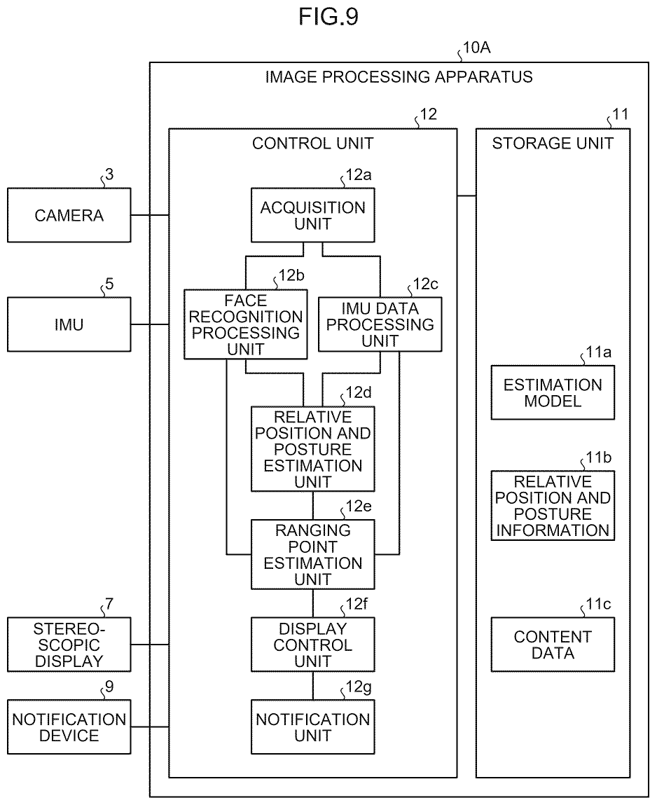

FIG. 3 is a block diagram illustrating the configuration example of the image processing apparatus 10 according to the embodiment of the present disclosure. Note that only components necessary for describing features of the embodiment of the present disclosure are illustrated in FIG. 3 and FIG. 9 (described later), and illustration of general components is omitted.

In other words, each of the components illustrated in FIG. 3 and FIG. 9 is functionally conceptual, and is not necessarily configured physically in an illustrated manner. For example, a specific form of distribution/integration of blocks is not limited to what is illustrated in the drawings, and a whole or part thereof can be functionally or physically distributed/integrated in an arbitrary unit according to various loads and usage conditions.

Furthermore, in the description with reference to FIG. 3 or FIG. 9, description of the already-described components may be simplified or omitted.

As illustrated in FIG. 3, the image processing apparatus 10 includes a storage unit 11 and a control unit 12. In addition, the camera 3, the IMU 5, and the stereoscopic display 7 are connected to the image processing apparatus 10. The image processing apparatus 10 is connected to each of the camera 3, the IMU 5, and the stereoscopic display 7 in a wired or wireless manner.

Since the camera 3, the IMU 5, and the stereoscopic display 7 have been described, description thereof is omitted here.

The storage unit 11 is realized by, for example, storage devices such as a random access memory (RAM), a read only memory (ROM), a flash memory, and a hard disk drive (HDD). In the example of FIG. 3, the storage unit 11 stores an estimation model 11a, relative position and posture information 11b, and content data 11c. In addition, the storage unit 11 stores a program according to the present embodiment (not illustrated).

The estimation model 11a is a model used in relative position and posture estimation processing executed by a relative position and posture estimation unit 12d (described later). For example, the estimation model 11a is a mathematical model including an equation that is established in a case where the relative position and posture between the ranging point R and the IMU 5 are correctly estimated (see “Monocular Visual-Inertial State Estimation With Online Initialization and Camera-IMU Extrinsic Calibration”, [Zhenfei, 2017]). The relative position and posture estimation unit 12d estimates the relative position and posture between the ranging point R and the IMU 5 and accuracy thereof by evaluating an error of the equation.

Furthermore, for example, the estimation model 11a may be a learning model learned by utilization of algorithm such as deep learning in such a manner as to output, in a case where the position and posture of the ranging point R, the position and posture of the IMU 5, and the like are input, the relative position and posture and the accuracy thereof based on the inputs.

The relative position and posture information 11b holds the relative position and posture most recently estimated by the relative position and posture estimation unit 12d, that is, estimated without failure in the face recognition up to a previous frame of the camera image, and accuracy thereof.

The content data 11c is data including a virtual object group to be displayed on the stereoscopic display 7.

The control unit 12 is a controller, and is realized by, for example, execution of a program according to the present embodiment, which program is stored in the storage unit 11, by a central processing unit (CPU), a micro processing unit (MPU), a graphics processing unit (GPU), or the like with the RAM as a work area. Also, the control unit 12 can be realized by, for example, an integrated circuit such as an application specific integrated circuit (ASIC) or a field programmable gate array (FPGA).

The control unit 12 includes an acquisition unit 12a, a face recognition processing unit 12b, an IMU data processing unit 12c, a relative position and posture estimation unit 12d, a ranging point estimation unit 12e, and a display control unit 12f, and realizes or executes functions and actions of information processing described below.

The acquisition unit 12a acquires the camera image captured by the camera 3 from the camera 3. In addition, the acquisition unit 12a acquires the IMU data measured by the IMU 5 from the IMU 5.

The face recognition processing unit 12b executes the face recognition processing of recognizing the face of the user U on the basis of the camera image acquired by the acquisition unit 12a. Specifically, the face recognition processing unit 12b estimates a position and posture of a predetermined ranging point R on the face of the user U on the basis of the camera image. Note that the face recognition processing unit 12b updates the position and posture of the ranging point R at a lower frequency than estimation processing of the position and posture of the IMU 5 by the IMU data processing unit 12c.

The IMU data processing unit 12c estimates the position and posture of the IMU 5 on the basis of the IMU data acquired by the acquisition unit 12a. Note that the IMU data processing unit 12c updates the position and posture of the IMU 5 more frequently than estimation processing of the position and posture of the ranging point R by the face recognition processing unit 12b.

In a case where both an estimation result of the position and posture of the ranging point R by the face recognition processing unit 12b and an estimation result of the position and posture of the IMU 5 by the IMU data processing unit 12c are updated, the relative position and posture estimation unit 12d estimates the relative position and posture between the ranging point R and the IMU 5 by using both the estimation results. As described above, the relative position and posture estimation unit 12d estimates the relative position and posture between the ranging point R and the IMU 5 and the accuracy thereof, for example, by evaluating the error of the above-described equation included in the estimation model 11a.

Furthermore, the relative position and posture estimation unit 12d outputs the estimated relative position and posture and accuracy to the ranging point estimation unit 12e. Furthermore, the relative position and posture estimation unit 12d stores the estimated relative position and posture and accuracy in the relative position and posture information 11b.

Note that although the relative position and posture estimated in such a manner by the relative position and posture estimation unit 12d has low accuracy immediately after the tracking starts to operate and the estimation is started, the accuracy increases every time a set of the estimation result based on the camera image and the estimation result based on the IMU data is input.

The ranging point estimation unit 12e integrates the estimation result based on the camera image and the estimation result based on the IMU data, and outputs the final position and posture of the ranging point R to the display control unit 12f. The ranging point estimation unit 12e converts the estimation result based on the IMU data into the position and posture of the ranging point R on the basis of the relative position and posture estimated by the relative position and posture estimation unit 12d.

In addition, for example, the ranging point estimation unit 12e determines a degree of reflecting the estimation result based on the IMU data in the final position and posture of the ranging point R on the basis of the accuracy of the relative position and posture estimated by the relative position and posture estimation unit 12d.

When the accuracy is low, the ranging point estimation unit 12e lowers the degree of reflecting the estimation result based on the IMU data in the estimation result of the final position and posture of the ranging point R.

On the other hand, as the accuracy is higher, the ranging point estimation unit 12e increases the degree of reflecting the estimation result based on the IMU data in the estimation result of the final position and posture of the ranging point R. In this case, as the degree is higher, the ranging point estimation unit 12e more frequently updates the final position and posture of the ranging point R to be output. As a result, the delay can be decreased.

For example, when the accuracy is less than a predetermined threshold, the ranging point estimation unit 12e estimates the final position and posture of the ranging point R by using only the estimation result based on the camera image without using the estimation result based on the IMU data, and outputs the estimated position and posture.

Furthermore, for example, when the accuracy is equal to or higher than the predetermined threshold, the ranging point estimation unit 12e determines the degree of reflecting the estimation result based on the IMU data in the final position and posture of the ranging point R according to the accuracy. Then, the ranging point estimation unit 12e estimates the final position and posture of the ranging point R by using both the estimation result based on the camera image and the estimation result based on the IMU data according to the degree, and outputs the estimated position and posture.

In addition, when the accuracy is high, the ranging point estimation unit 12e can estimate the final position and posture of the ranging point R by using only the estimation result based on the IMU data and output the estimated position and posture even in a case where the position and posture of the ranging point R cannot be estimated from the camera image due to the face of the user U being out of the angle of view FV.

The display control unit 12f estimates right and left viewpoint positions of the user U on the basis of the final position and posture of the ranging point R which position and posture are output from the ranging point estimation unit 12e, generates a stereoscopic image directed to the estimated viewpoint positions, and displays the generated stereoscopic image on the stereoscopic display 7.

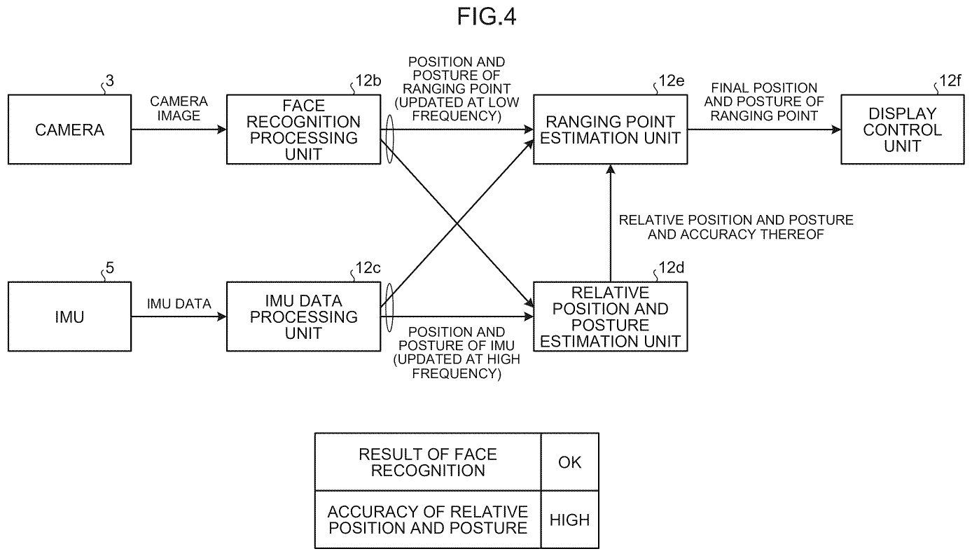

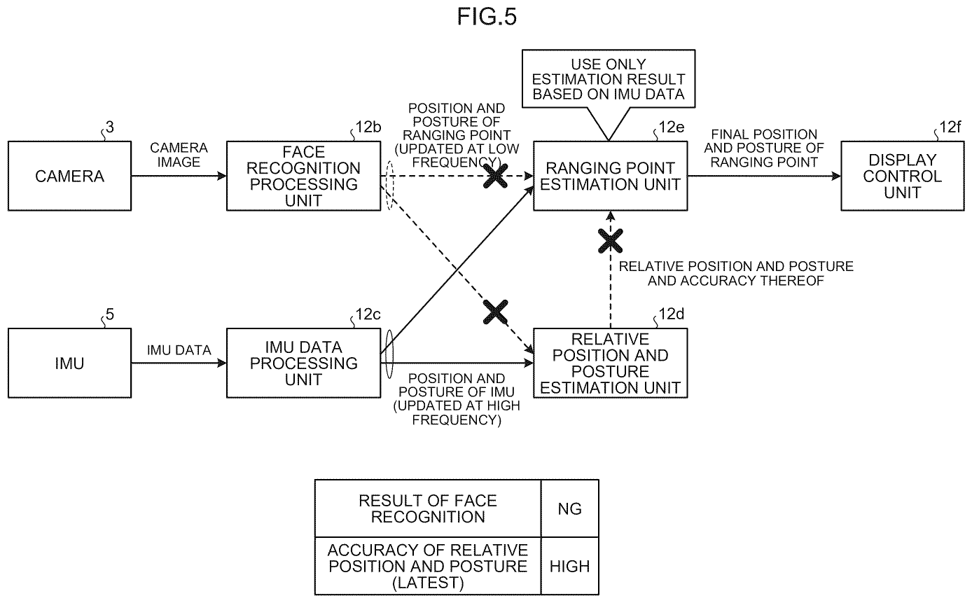

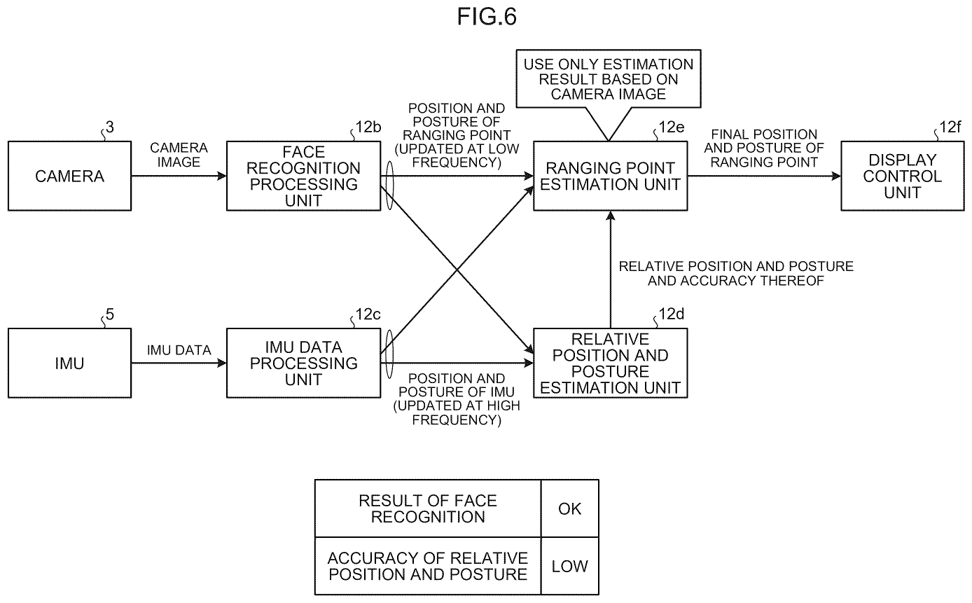

In order to make it easier to understand the above description, switching of operations in the image processing method executed by the image processing apparatus 10 will be described with reference to FIG. 4 to FIG. 6. FIG. 4 is an explanatory diagram (part 1) of the image processing method executed by the image processing apparatus 10. FIG. 5 is an explanatory diagram (part 2) of the image processing method executed by the image processing apparatus 10. FIG. 6 is an explanatory diagram (part 3) of the image processing method executed by the image processing apparatus 10.

In FIG. 4 to FIG. 6, switching of operations according to a combination of a result of the face recognition based on the camera image and the accuracy of the relative position and posture is illustrated.

Note that “OK” of the result of the face recognition indicates a case where the face of the user U is not out of the angle of view FV (that is, when the face recognition is successful). Furthermore, “NG” indicates a case where the face of the user U is out of the angle of view FV (that is, when the face recognition fails).

Furthermore, “high” of the accuracy of the relative position and posture indicates a case where the accuracy of the relative position and posture estimated by the relative position and posture estimation unit 12d is, for example, equal to or higher than a predetermined threshold. Furthermore, “low” indicates a case where the accuracy is, for example, lower than the threshold.

As illustrated in FIG. 4, in a case where the result of the face recognition is “OK”, the face recognition processing unit 12b estimates the position and posture of the ranging point R on the basis of the camera image from the camera 3, and outputs an estimation result to the relative position and posture estimation unit 12d and the ranging point estimation unit 12e.

On the other hand, the IMU data processing unit 12c estimates the position and posture of the IMU 5 on the basis of the IMU data from the IMU 5, and outputs an estimation result to the relative position and posture estimation unit 12d and the ranging point estimation unit 12e.

Then, the relative position and posture estimation unit 12d estimates the relative position and posture between the ranging point R and the IMU 5 and the accuracy thereof on the basis of the estimation results of both the face recognition processing unit 12b and the IMU data processing unit 12c. Then, the relative position and posture estimation unit 12d outputs the relative position and posture and the accuracy thereof to the ranging point estimation unit 12e.

In a case where the accuracy from the relative position and posture estimation unit 12d is “high”, the ranging point estimation unit 12e estimates the final position and posture of the ranging point R on the basis of the estimation results of the face recognition processing unit 12b, and both the IMU data processing unit 12c and the relative position and posture estimation unit 12d. Then, the ranging point estimation unit 12e outputs an estimation result to the display control unit 12f.

Furthermore, as illustrated in FIG. 5, in a case where the result of the face recognition is “NG”, since not being able to estimate the position and posture of the ranging point R on the basis of the camera image, the face recognition processing unit 12b does not output the estimation result to the relative position and posture estimation unit 12d and the ranging point estimation unit 12e for the current frame of the camera image.

On the other hand, the IMU data processing unit 12c estimates the position and posture of the IMU 5 on the basis of the IMU data from the IMU 5, and outputs an estimation result to the relative position and posture estimation unit 12d and the ranging point estimation unit 12e.

Then, since the estimation result by the face recognition processing unit 12b is not output, the relative position and posture estimation unit 12d does not estimate the relative position and posture and the accuracy based thereon and does not perform an output to the ranging point estimation unit 12e.

Then, in this case, when the accuracy of the latest relative position and posture is “high”, the ranging point estimation unit 12e estimates the final position and posture of the ranging point R by using only the estimation result based on the IMU data.

Specifically, the ranging point estimation unit 12e refers to the relative position and posture and accuracy estimated most recently up to the previous frame held in the relative position and posture information 11b, and converts the estimation result based on the IMU data into the position and posture of the ranging point R when the accuracy is “high”. Then, the ranging point estimation unit 12e outputs the converted value to the display control unit 12f.

In addition, as illustrated in FIG. 6, in a case where the result of the face recognition is “OK”, the face recognition processing unit 12b estimates the position and posture of the ranging point R on the basis of the camera image from the camera 3, and outputs an estimation result to the relative position and posture estimation unit 12d and the ranging point estimation unit 12e.

On the other hand, the IMU data processing unit 12c estimates the position and posture of the IMU 5 on the basis of the IMU data from the IMU 5, and outputs an estimation result to the relative position and posture estimation unit 12d and the ranging point estimation unit 12e.

Then, the relative position and posture estimation unit 12d estimates the relative position and posture between the ranging point R and the IMU 5 and the accuracy thereof on the basis of the estimation results of both the face recognition processing unit 12b and the IMU data processing unit 12c. Then, the relative position and posture estimation unit 12d outputs the relative position and posture and the accuracy thereof to the ranging point estimation unit 12e.

Then, in a case where the accuracy from the relative position and posture estimation unit 12d is “low”, the ranging point estimation unit 12e does not use the estimation result based on the IMU data, and estimates the final position and posture of the ranging point R by using only the estimation result based on the camera image. Then, the ranging point estimation unit 12e outputs an estimation result to the display control unit 12f.

Note that examples of a case corresponding to FIG. 6 include an initial stage of a tracking operation, immediately after the relative position and posture change, and the like.

### <<3. Processing Procedure>>

Next, a processing procedure executed by the image processing apparatus 10 according to the present embodiment will be described with reference to FIG. 7 and FIG. 8.

FIG. 7 is a flowchart (part 1) illustrating the processing procedure executed by the image processing apparatus 10.

FIG. 8 is a flowchart (part 2) illustrating the processing procedure executed by the image processing apparatus 10. Note that the processing procedure corresponding to one frame of the camera image is illustrated in FIG. 7 and FIG. 8.

The acquisition unit 12a acquires the camera image from the camera 3 (Step S101). Then, the face recognition processing unit 12b executes the face recognition processing on the basis of the acquired camera image (Step S102).

In parallel with Step S101 and S102, the acquisition unit 12a acquires the IMU data from the IMU 5 (Step S103). Then, the IMU data processing unit 12c executes IMU data processing on the basis of the acquired IMU data (Step S104).

Then, it is determined whether face recognition has succeeded in the face recognition processing (Step S105). In a case where it is determined that the face recognition has succeeded (Step S105, Yes), 0 is set to an estimation counter based only on the IMU data (Step S106).

Then, the relative position and posture estimation unit 12d estimates the relative position and posture by using the estimation result based on the camera image by the face recognition processing unit 12b and the estimation result based on the IMU data by the IMU data processing unit 12c (Step S107).

Then, the ranging point estimation unit 12e determines whether the accuracy of the relative position and posture estimated by the relative position and posture estimation unit 12d is equal to or higher than the predetermined threshold (Step S108).

In a case where the accuracy of the relative position and posture is equal to or higher than the threshold (Step S108, Yes), the ranging point estimation unit 12e converts the estimation result based on the IMU data into the ranging point by using the relative position and posture (Step S109). Then, the ranging point estimation unit 12e estimates the final ranging point R from the ranging point based on the camera image and the ranging point based on the IMU data (Step S110).

On the other hand, in a case where the accuracy of the relative position and posture is lower than the threshold (Step S108, No), the ranging point estimation unit 12e estimates the ranging point based on the camera image as the final ranging point R (Step S111).

Then, the display control unit 12f generates the stereoscopic image on the basis of the final ranging point R, displays the generated stereoscopic image on the stereoscopic display 7 (Step S112), and ends the processing.

In addition, in a case where it is determined in Step S105 that the face recognition has failed (Step S105, No), as illustrated in FIG. 8, the ranging point estimation unit 12e determines whether the accuracy of the latest relative position and posture is equal to or higher than the predetermined threshold (Step S113).

In a case where the accuracy of the latest relative position and posture is equal to or higher than the threshold (Step S113, Yes), the ranging point estimation unit 12e subsequently determines whether the estimation counter based only on the IMU data is lower than a predetermined threshold (Step S114). Note that the threshold in Step S114 is different from the threshold in Step S108 and Step S113.

In a case where the estimation counter based only on the IMU data is lower than the predetermined threshold (Step S114, Yes), the relative position and posture estimation unit 12d converts the estimation result based on the IMU data into a ranging point by using the latest relative position and posture (Step S115). Then, the ranging point estimation unit 12e estimates the converted value as the final ranging point R (Step S116).

In addition, the ranging point estimation unit 12e increments the estimation counter based only on the IMU data (Step S117). Then, the display control unit 12f generates the stereoscopic image on the basis of the final ranging point R, displays the generated stereoscopic image on the stereoscopic display 7 (Step S118), and ends the processing.

On the other hand, in a case where the accuracy of the latest relative position and posture is lower than the threshold (Step S113, No) or in a case where the estimation counter based only on the IMU data is equal to or higher than the threshold (Step S114, No), the ranging point estimation unit 12e determines that the estimation of the ranging point R is impossible (Step S119). Then, the processing ends.

Note that in the IMU 5, a drift of the estimation result due to time is generated due to a mechanism, that is, an error of the estimated position and posture increases with the lapse of time. The estimation counter based only on the IMU data illustrated in FIG. 7 and FIG. 8 is provided to avoid the influence. In a case where the estimation of the ranging point R based only on the IMU data continues predetermined number of times or more according to this counter, the ranging point estimation unit 12e regards that the estimation of the final ranging point R is impossible.

### 4. Modification Example

Incidentally, there are some modification examples for the above-described embodiment of the present disclosure.

<4-1. Case where Notification to User is Performed>

In the present embodiment, it is difficult to estimate the relative position and posture unless the user U wearing the IMU 5 moves the head to some extent after the start of the tracking operation of the viewpoint positions of the user U. In order to prevent this, for example, a method of giving some kind of notification to the user U on the basis of a state of the estimation of the relative position and posture is conceivable.

FIG. 9 is a block diagram illustrating a configuration example of an image processing apparatus 10A according to a modification example. Note that since FIG. 9 corresponds to FIG. 3, only points different from FIG. 3 will be described here.

As illustrated in FIG. 9, in the image processing apparatus 10A according to the modification example, a control unit 12 further includes a notification unit 12g. In addition, a notification device 9 is further connected to the image processing apparatus 10A. The notification device 9 is a device that presents visual information, audio information, tactile information, and the like as the notification to a user U.

The notification unit 12g notifies the user U whether current tracking is performed only on the basis of a camera image, is performed by utilization of the camera image and IMU data in combination, or is performed only on the basis of the IMU data. In a case where the movement of the user U is small and the estimation of the relative position and posture is not performed well (for example, accuracy described above is low), the notification unit 12g may give notification urging the user U to move. Alternatively, the notification unit 12g may give notification of prompting confirmation of an attachment state of an IMU 5.

In a case where the notification is performed as visual information, the notification unit 12g may perform the notification by display on a stereoscopic display 7.

### <4-2. Hysteresis Control>

Furthermore, in a case where the processing procedure illustrated in FIG. 7 and FIG. 8 is executed for each frame of the camera image, it is conceivable that operations are frequently switched due to an influence of disturbance such as a noise component. In order to prevent this, for example, hysteresis control may be performed.

For example, in at least one of conditional branches of the operation switching illustrated in FIG. 7 and FIG. 8, the operations may be switched in a case where the same condition continues for predetermined number of frames or more.

### <4-3. Others>

Furthermore, of the processes described in the above embodiments of the present disclosure, all or some of the processes described to be performed automatically may be performed manually, or all or some of the processes described to be performed manually may be performed automatically by a known method. In addition, the process procedures, specific names, and information including various data and parameters, which are described in the above description or illustrated in the drawings, can be appropriately changed unless otherwise specified. For example, various information illustrated in the drawings are not limited to the illustrated information.

Furthermore, the component elements of the devices are illustrated as functional concepts but are not necessarily required to be physically configured as illustrated. In other words, specific forms of distribution or integration of the devices are not limited to those illustrated, and all or some of the devices may be configured by being functionally or physically distributed or integrated in appropriate units, according to various loads or usage conditions.

Furthermore, the embodiments of the present disclosure described above can be appropriately combined within a range consistent with the contents of the processing. Furthermore, the orders of the steps illustrated in the sequence diagrams or flowcharts of the present embodiment can be changed appropriately.

### <<5. Hardware Configuration>>

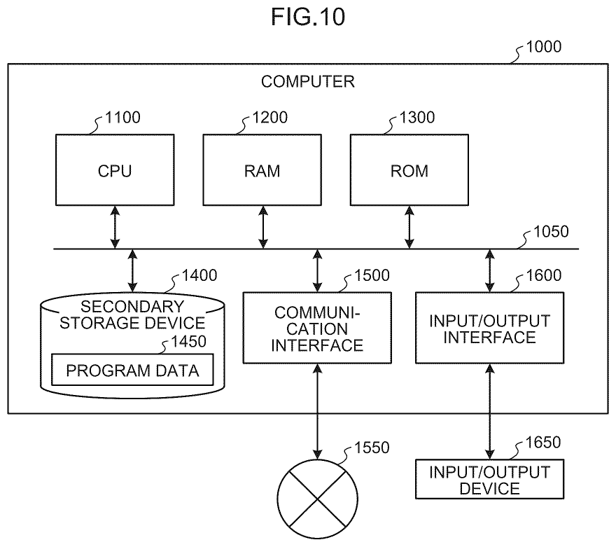

Furthermore, the image processing apparatuses 10 or 10A according to the embodiments of the present disclosure described above are implemented by, for example, a computer 1000 having a configuration as illustrated in FIG. 10. FIG. 10 is a hardware configuration diagram illustrating an example of the computer 1000 implementing the functions of the image processing apparatuses 10 or 10A. The computer 1000 includes a CPU 1100, a RAM 1200, a ROM 1300, a secondary storage device 1400, a communication interface 1500, and an input/output interface 1600. The respective units of the computer 1000 are connected by a bus 1050.

The CPU 1100 is operated on the basis of programs stored in the ROM 1300 or the secondary storage device 1400 to control the respective units. For example, the CPU 1100 deploys a program stored in the ROM 1300 or the secondary storage device 1400 to the RAM 1200, and performs processing corresponding to each of various programs.

The ROM 1300 stores a boot program, such as a basic input output system (BIOS), performed by the CPU 1100 when the computer 1000 is booted, a program depending on the hardware of the computer 1000, and the like.

The secondary storage device 1400 is a computer-readable recording medium that non-transitorily records a program performed by the CPU 1100, data used by the program, and the like. Specifically, the secondary storage device 1400 is a recording medium that records a program according to an embodiment of the present disclosure or a program according to a modification, which is an example of program data 1450.

The communication interface 1500 is an interface for connecting the computer 1000 to an external network 1550. For example, the CPU 1100 receives data from another device or transmits data generated by the CPU 1100 to another device, via the communication interface 1500.

The input/output interface 1600 is an interface for connecting an input/output device 1650 and the computer 1000. For example, the CPU 1100 receives data from an input device such as a keyboard or mouse via the input/output interface 1600. In addition, the CPU 1100 transmits data to an output device such as a display, speaker, or printer via the input/output interface 1600. Furthermore, the input/output interface 1600 may function as a media interface that reads a program or the like recorded on a predetermined recording medium. The medium includes, for example, an optical recording medium such as a digital versatile disc (DVD) or phase change rewritable disk (PD), a magneto-optical recording medium such as a magneto-optical disk (MO), a tape medium, a magnetic recording medium, a semiconductor memory, or the like.

For example, when the computer 1000 functions as the image processing apparatuses 10 or 10A, the CPU 1100 of the computer 1000 executes a program loaded on the RAM 1200 to implement a function of the control unit 12. In addition, the secondary storage device 1400 stores a program according to the present disclosure, a program according to a modification, and data in the storage unit 11. Note that the CPU 1100 executes the program data 1450 read from the secondary storage device 1400, but in another example, the CPU 1100 may acquire these programs from another device via the external network 1550.

### 6. CONCLUSION

As described above, according to an embodiment of the present disclosure, the image processing apparatus 10 (corresponding to an example of an “information processing apparatus”) includes the control unit 12. The control unit 12 acquires the camera image from the camera 3 a relative position of which with respect to the stereoscopic display 7 (corresponding to an example of a “display”) is fixed.

In addition, the control unit 12 acquires the IMU data that is the measurement data of the IMU 5 worn by the user U viewing the stereoscopic display 7. Furthermore, the control unit 12 executes the face recognition processing of estimating the position and posture of the face of the user U on the basis of the camera image. Furthermore, the control unit 12 determines whether the execution of the face recognition processing is successful. Furthermore, in a case where it is determined that the execution of the face recognition processing has failed, the control unit 12 continues the estimation of the position and posture of the face of the user U on the basis of the IMU data. Thus, when the face of the user U is tracked and the position and posture of the ranging point R are estimated, it is possible to reduce the delay and improve the robustness of a case where the face of the user U is out of the angle of view FV. That is, it is possible to improve the tracking performance of when the face of the user U is tracked.

Although embodiments of the present disclosure have been described above, a technical scope of the present disclosure is not limited to the above-described embodiments as they are, and various modifications can be made within the spirit and scope of the present disclosure. In addition, components of different embodiments and modification examples may be arbitrarily combined.

Furthermore, an effect in each of the embodiments described in the present specification is merely an example and is not a limitation, and there may be a different effect.

Note that the present technology can also have the following configurations.

(1)

An information processing apparatus comprising:
a control unit that acquires a camera image from a camera a relative position of which with respect to a display is fixed,
acquires IMU data that is measurement data of an IMU worn by a user viewing the display,
executes face recognition processing of estimating a position and posture of a face of the user on a basis of the camera image,
determines whether the execution of the face recognition processing is successful, and
continues the estimation of the position and posture of the face of the user on a basis of the IMU data in a case where it is determined that the execution of the face recognition processing has failed.
   (2)

The information processing apparatus according to (1), wherein
the control unit estimates a position and posture of a ranging point corresponding to a specific part of the face of the user.
   (3)

The information processing apparatus according to (2), wherein
the control unit
   generates a stereoscopic image on a basis of the estimated position and posture of the ranging point, and
   outputs the stereoscopic image to the display.
      (4)

The information processing apparatus according to (3), wherein
the control unit generates the stereoscopic image that is a parallax image group directed to right and left eyes of the user according to viewpoint positions of the user which viewpoint positions are estimated from the estimated position and posture of the ranging point.
   (5)

The information processing apparatus according to (3) or (4), wherein
the control unit estimates a relative position and posture between the ranging point and the IMU and accuracy of the relative position and posture by using an estimation result of the position and posture of the ranging point which estimation result is based on the camera image and an estimation result of a position and posture of the IMU which estimation result is based on the IMU data.
   (6)

The information processing apparatus according to (5), wherein
the control unit integrates the estimation result based on the camera image and the estimation result based on the IMU data and estimates a final position and posture of the ranging point according to the accuracy.
   (7)

The information processing apparatus according to (6), wherein
the control unit determines a degree of reflecting the estimation result based on the IMU data in the estimation result based on the camera image according to the accuracy.
   (8)

The information processing apparatus according to (6) or (7), wherein
the control unit converts the estimation result of the position and posture of the IMU which estimation result is based on the IMU data into the position and posture of the ranging point by using the relative position and posture.
   (9)

The information processing apparatus according to (6), (7), or (8), wherein
the control unit estimates the final position and posture of the ranging point by using only the estimation result based on the camera image in a case where the accuracy is lower than a predetermined threshold.
   (10)

The information processing apparatus according to any one of (6) to (9), wherein
in a case where it is determined that the execution of the face recognition processing has failed, the control unit estimates the final position and posture of the ranging point by using only the estimation result based on the IMU data when the accuracy of the relative position and posture estimated most recently up to a previous frame of the camera image is equal to or higher than a predetermined threshold.
   (11)

The information processing apparatus according to (10), wherein
the control unit determines that the estimation of the ranging point is impossible in a case where the estimation of the final position and posture of the ranging point by utilization only of the estimation result based on the IMU data continues predetermined number of times or more.
   (12)

The information processing apparatus according to any one of (1) to (11), wherein
the IMU is provided in a manner of being attachable to a head of the user at any attachment position and in any attachment form.
   (13)

An information processing method comprising:
acquiring a camera image from a camera a relative position of which with respect to a display is fixed,
acquiring IMU data that is measurement data of an IMU worn by a user viewing the display,
executing face recognition processing of estimating a position and posture of a face of the user on a basis of the camera image,
determining whether the execution of the face recognition processing is successful, and
continuing the estimation of the position and posture of the face of the user on a basis of the IMU data in a case where it is determined that the execution of the face recognition processing has failed.
   (14)

A computer-readable recording medium recording an information processing program that causes a computer to execute processing of:
acquiring a camera image from a camera a relative position of which with respect to a display is fixed,
acquiring IMU data that is measurement data of an IMU worn by a user viewing the display,
executing face recognition processing of estimating a position and posture of a face of the user on the basis of the camera image,
determining whether the execution of the face recognition processing is successful, and
continuing the estimation of the position and posture of the face of the user on the basis of the IMU data in a case where it is determined that the execution of the face recognition processing has failed.

### REFERENCE SIGNS LIST

3 CAMERA
5 IMU
7 STEREOSCOPIC DISPLAY
9 NOTIFICATION DEVICE
10, 10A IMAGE PROCESSING DEVICE
11 STORAGE UNIT
11a ESTIMATION MODEL
11b RELATIVE POSITION AND POSTURE INFORMATION
11c CONTENT DATA
12 CONTROL UNIT
12a ACQUISITION UNIT
12b FACE RECOGNITION PROCESSING UNIT
12c IMU DATA PROCESSING UNIT
12d RELATIVE POSITION AND POSTURE ESTIMATION UNIT
12e RANGING POINT ESTIMATION UNIT
12f DISPLAY CONTROL UNIT
12g NOTIFICATION UNIT
FV FIELD OF VIEW
R RANGING POINT
U USER

1. An information processing apparatus comprising:
a control unit that acquires a camera image from a camera a relative position of which with respect to a display is fixed,
acquires IMU data that is measurement data of an IMU worn by a user viewing the display,
executes face recognition processing of estimating a position and posture of a face of the user on a basis of the camera image,
determines whether the execution of the face recognition processing is successful, and
continues the estimation of the position and posture of the face of the user on a basis of the IMU data in a case where it is determined that the execution of the face recognition processing has failed.

2. The information processing apparatus according to claim 1, wherein
the control unit estimates a position and posture of a ranging point corresponding to a specific part of the face of the user.

3. The information processing apparatus according to claim 2, wherein
the control unit
generates a stereoscopic image on a basis of the estimated position and posture of the ranging point, and
outputs the stereoscopic image to the display.

4. The information processing apparatus according to claim 3, wherein
the control unit generates the stereoscopic image that is a parallax image group directed to right and left eyes of the user according to viewpoint positions of the user which viewpoint positions are estimated from the estimated position and posture of the ranging point.

5. The information processing apparatus according to claim 3, wherein
the control unit estimates a relative position and posture between the ranging point and the IMU and accuracy of the relative position and posture by using an estimation result of the position and posture of the ranging point which estimation result is based on the camera image and an estimation result of a position and posture of the IMU which estimation result is based on the IMU data.

6. The information processing apparatus according to claim 5, wherein
the control unit integrates the estimation result based on the camera image and the estimation result based on the IMU data and estimates a final position and posture of the ranging point according to the accuracy.

7. The information processing apparatus according to claim 6, wherein
the control unit determines a degree of reflecting the estimation result based on the IMU data in the estimation result based on the camera image according to the accuracy.

8. The information processing apparatus according to claim 6, wherein
the control unit converts the estimation result of the position and posture of the IMU which estimation result is based on the IMU data into the position and posture of the ranging point by using the relative position and posture.

9. The information processing apparatus according to claim 6, wherein
the control unit estimates the final position and posture of the ranging point by using only the estimation result based on the camera image in a case where the accuracy is lower than a predetermined threshold.

10. The information processing apparatus according to claim 6, wherein
in a case where it is determined that the execution of the face recognition processing has failed, the control unit estimates the final position and posture of the ranging point by using only the estimation result based on the IMU data when the accuracy of the relative position and posture estimated most recently up to a previous frame of the camera image is equal to or higher than a predetermined threshold.

11. The information processing apparatus according to claim 10, wherein
the control unit determines that the estimation of the ranging point is impossible in a case where the estimation of the final position and posture of the ranging point by utilization only of the estimation result based on the IMU data continues predetermined number of times or more.

12. The information processing apparatus according to claim 1, wherein
the IMU is provided in a manner of being attachable to a head of the user at any attachment position and in any attachment form.

13. An information processing method comprising:
acquiring a camera image from a camera a relative position of which with respect to a display is fixed,
acquiring IMU data that is measurement data of an IMU worn by a user viewing the display,
executing face recognition processing of estimating a position and posture of a face of the user on a basis of the camera image,
determining whether the execution of the face recognition processing is successful, and
continuing the estimation of the position and posture of the face of the user on a basis of the IMU data in a case where it is determined that the execution of the face recognition processing has failed.
